(19) United States
(12) Patent Application Publication
(10) Pub. No.: US 2005/0197873 A1
(43) Pub. Date: Sep. 8, 2005

(54) Method and apparatus for stakeholder alignment

(76) Inventor: Steven Edward Little, Pittsburgh, PA (US)

Correspondence Address: BLYNN L. SHIDELER;THE BLK LAW GROUP, 3500 BROKKTREE ROAD, SUITE 200, WEXFORD, PA, 15090, US

(21) Appl. No.: 11/057,733

(22) Filed: Feb. 14, 2005

Related U.S. Application Data
(60) Provisional application No. 60/549,848, filed on Mar. 3, 2004.

(51) Int. Cl. G06F 17/60

(52) U.S. Cl. 705/7

(57) ABSTRACT

A process and apparatus for creating Guiding Principles and Leverage Points for aligning Stakeholder Interests of an Organizational Group diffuses individual Stakeholder interests and biases. The individual Stakeholder interests are eliminated, or at least minimized, through customized Stakeholder questions presented to representative Stakeholders in an ordered fashion. The ordered fashion positions questions relating to matters external to the Organizational Group before questions relating to matters internal to the Organizational Group. An Affinity Analysis on Stakeholder interview responses provides the analysis needed for creating Guiding Principles and Leverage Points for aligning Stakeholder Interests that are approved by the Stakeholder leaders and presented to the Stakeholders. The apparatus includes i) a graphical representation of a Stakeholder Network; ii) an ordered customized Stakeholder Interview Worksheet; iii) a computer database of individual Stakeholder responses the Stakeholder Interview Worksheet; and iv) at least one graphical Affinity Analysis diagram of separated responses from the computer database.

### RELATED APPLICATION

This application claims the benefit of provisional patent application Ser. No. 60/549,848 filed Mar. 3, 2004 entitled “Use of Needs Summary, Guiding Principles and Leverage Points for Stakeholder Alignment.”

### BACKGROUND OF THE INVENTION

1. Field of the Invention

The present invention relates to a systematic, efficient process for alignment of stakeholders so that they have common understanding and expectations.

2. Background Information

I, Steven E. Little, residing at 107 Loire Valley Drive, Pittsburgh, Pa. 15209, have invented a better process for aligning stakeholders which is described hereinafter in detail. The object of my invention is a universal, efficient and effective process to align stakeholders so that they have common understanding and expectations. The need for this exists because many organizations spend large amounts of money on teams, projects and initiatives that do not have any stakeholder alignment, resulting in very unproductive groups, teams, projects and initiatives when there is not stakeholder alignment. While there are many management books about business process and technique, many miss the fundamental issues that need to be addressed. Other methods for “stakeholder alignment” use large meetings or group consensus meeting techniques as opposed to a series of individual stakeholder meetings coupled with stakeholder leadership involvement. Other known techniques which do apply individual interviews of stakeholders fail to properly organize or order the interview to maximize the results. Further, other stakeholder alignment techniques do not incorporate the complete set of activities necessary to provide a comprehensive, universal application process.

In order to define the precise scope and context of the present invention it is helpful to define the terms used within the meaning of this application. A “Stakeholder” within the meaning of the present application is an individual or group of individuals acting on behalf of an organizational group that has a specific interest (or “stake”) in a given activity. For example, a stakeholder of an organizational group may be an employee of a company, a department of a company, a student at an educational institution, an individual member of a formal association, etc.

A “Stakeholder Network” within the meaning of the present application is the relationship among the set of stakeholders for a given organizational entity and relative to the given project. For example, the stakeholders may be related as employees of the organization or, alternatively, as different departments (Sales, Research and Development, IT, Production, Human Resources, etc). The set of variables under consideration represent the “Dimensions” for data collection and analysis. An “Affinity Diagram” or a “KJ diagram” within the meaning of this application is a diagram used in applying quantitative analysis to a set of fundamentally qualitative data, as developed by Jiro Kawakita. “Affinity States” within the meaning of this application refer to the clusters of information that are formed during the creation of the Affinity Diagram. In other words, an Affinity State is a grouped set of related qualitative data.

The objects of the present invention are to provide a systematic, efficient, effective method and apparatus for alignment of stakeholders so that they have common understanding and expectations.

### SUMMARY OF THE INVENTION

The above objects are achieved with the process and apparatus for creating Guiding Principles and Leverage Points for aligning Stakeholder Interests of an Organizational Group according to the present invention. The present invention diffuses individual Stakeholder interests and biases. The individual Stakeholder interests are eliminated, or at least minimized in the present invention, through customized Stakeholder questions presented in an ordered fashion to a representative set of Stakeholders in individual interviews. The ordered fashion positions questions relating to matters external to the Organizational Group before questions relating to matters internal to the Organizational Group. An Affinity Analysis on responses from the Stakeholder interviews provides the analysis needed for creating Guiding Principles and Leverage Points for aligning Stakeholder Interests that are approved by the Stakeholder leaders and presented to the Stakeholders. The apparatus includes i) a graphical representation of a Stakeholder Network; ii) an ordered customized Stakeholder Interview Worksheet; iii) a computer database of individual Stakeholder responses the Stakeholder Interview Worksheet; and iv) at least one graphical Affinity Analysis diagram of separated responses from the computer database.

A more detailed summary of the process according to the present invention for creating Guiding Principles and Leverage Points for aligning Stakeholder Interests of a given Organizational Group having a defined set of Stakeholders and Stakeholder Leaders follows hereinafter. The process comprises the steps of: A) Establishing a scope for the alignment process and defining a Stakeholder Network within the Organizational Group with input from Stakeholder Leaders (and including identifying the Stakeholders and representative group of Stakeholders); B) Creating customized Stakeholder questions in an ordered fashion, wherein the ordered fashion positions questions relating to matters external to the Organizational Group before questions relating to matters internal to the Organizational Group; C) Interviewing representative Stakeholders using the customized Stakeholder questions in an ordered fashion, wherein the Stakeholders are asked questions relating to matters external to the Organizational Group before being asked questions relating to matters internal to the Organizational Group; D) Coding of Stakeholder interview responses in a common format; E) Separating responses from all Stakeholder interviews at least into responses to questions relating to matters external to the Organizational Group and responses to questions relating to matters internal to the Organizational Group; F) Conducting an Affinity Analysis on the separated responses from all the Stakeholder interviews; G) Reporting results of steps B-F to at least the Stakeholder Leaders, wherein the reporting includes graphically displaying at least some of the material associated with steps A-F to the Stakeholder Leaders; H) Creating Guiding Principles based upon the results, wherein the guiding principles are approved by the Stakeholder Leaders; I) Creating Leverage Points based upon the guiding principles, wherein the leverage points are approved by the Stakeholder Leaders; and J) Report results, Guiding Principles and Leverage Points to Stakeholders.

A more detailed summary of the apparatus according to the present invention for assisting in the creation of Guiding Principles and Leverage Points for aligning Stakeholder Interests of a given Organizational Group having a defined set of Stakeholders and Stakeholder Leaders follows hereinafter. The apparatus according to the present invention includes: A) A graphical representation of a Stakeholder Network within the Organizational Group, wherein said graphical representation of a Stakeholder Network is created with input from Stakeholder Leaders; B) A customized Stakeholder Interview Worksheet in which questions relating to matters external to the Organizational Group are positioned in a first grouping physically separated from questions relating to matters internal to the Organizational Group in a second following grouping, whereby Stakeholder questions are presented in an ordered fashion; C) A computer database of individual Stakeholder responses to the questions of the Stakeholder Interview Worksheet; and D) at least one graphical Affinity Analysis diagram of separated responses from the computer database of the individual Stakeholder responses.

In one particular aspect or embodiment of the present invention the Stakeholder Interview Worksheet is created in which the ordered fashion positions questions relating to matters external to the Organizational Group in a first grouping physically separated from questions relating to matters internal to the Organizational Group in a second following grouping. The grouped questions relating to matters external to the Organizational Group in the first grouping may include i) at least one question relating to the Stakeholders perceived listing of competitors of the Organizational group and ii) at least one question relating to the Stakeholders perceived major external factors driving change for the Organizational Group. The grouped questions relating to matters internal to the Organizational Group in the second grouping may include i) at least one question relating the Stakeholders perceived role within the Organizational Group, ii) at least one question relating to the Stakeholders perceived Stakeholder Network within the Organizational Group, iii) at least one question relating to the Stakeholders perceived wins and losses of the Organizational Group, and iv) at least one question relating to the Stakeholders perceived tactical and/or strategic opportunities for the Organizational Group.

In one particular aspect or embodiment of the present invention the step of Interviewing Stakeholders using the customized Stakeholder questions in an ordered fashion is performed individually with each representative Stakeholder, wherein each Stakeholders is individually asked questions relating to matters external to the Organizational Group before being individually asked questions relating to matters internal to the Organizational Group. The representative Stakeholders are those selected to give a meaningful collection of input from each “group” of Stakeholders. For small sets of Stakeholders the representative Stakeholders could be all of the Stakeholders. For many applications, such as a company with 10,000 employees worldwide, the representative Stakeholders are a subset that provides meaningful input from each desired grouping of Stakeholders (e.g. marketing, sales, engineering, etc.).

In one particular aspect or embodiment of the present invention the step of coding of Stakeholder interview responses in a common format includes forming a computer database of said Stakeholder interview responses and the step of conducting an Affinity Analysis on the separated responses from all the Stakeholder interviews is performed using computer graphics software.

In one particular aspect or embodiment of the present invention the step of reporting results of steps B-F to at least the Stakeholder Leaders includes graphically displaying i) at least some Affinity Analysis diagrams created in step F, ii) the Stakeholder Network defined in Step A, and iii) a Stakeholder Interview Worksheet created in Step B.

In one particular aspect or embodiment of the present invention there are 5-9 Guiding Principles created in step H and there are 5-7 Leverage Points created in step I.

Within the meaning of the present application steps A-G of the process according to the present invention for creating Guiding Principles and Leverage Points for aligning Stakeholder Interests of a given Organizational Group may be grouped together as the “Needs Summary” portion of the method according to the present invention. In other words the Needs Summary is a specific process incorporating a specific set of ordered or “Dimensional Questions”, presented to Stakeholders and the results then analyzed using a KJ (Jiro Kawakita) Method or Affinity Analysis. The “Guiding Principles” portion of the present process within the meaning of this application is a process applied after the completion of the Needs Summary portion which defines the fundamental activities by which the stakeholder network will define achievement and success. The “Leverage Points” portion of the present process is a process applied after the completion of Needs Summary and Guiding Principles portions which characterizes the means by which achievement of the Guiding Principles will occur.

These and other advantages of the present invention will be clarified in the description of the preferred embodiments taken together with the attached drawings in which like reference numerals represent like elements throughout.

### BRIEF DESCRIPTION OF THE DRAWING

FIG. 1 is an overview schematic flow chart of a process of creating Guiding Principles and Leverage Points for aligning Stakeholder Interests of a given Organizational Group having a defined set of Stakeholders and Stakeholder Leaders according to the present invention;

FIG. 2 is a representative example of a Stakeholder Interview Worksheet for use in the Stakeholder Interviews in the process according to the present invention;

FIG. 3 is a schematic representation of the Stakeholder Interview structure for the Stakeholder interviews in the process according to the present invention;

FIG. 4 is a detailed schematic flow chart of the initial eight steps of the process of creating Guiding Principles and Leverage Points for aligning Stakeholder Interests of a given Organizational Group according to the present invention;

FIG. 5 is a detailed schematic flow chart of the final four steps of the process of creating Guiding Principles and Leverage Points for aligning Stakeholder Interests of a given Organizational Group according to the present invention;

FIG. 6 is a graphic Stakeholder Network for a representative example of the process of the present invention;

FIG. 7 is a representative example of a portion of coded Stakeholder responses to individual interview questioning an example of the process of the present invention;

FIG. 8 is an example of an Affinity Diagram from an Affinity Analysis in a representative example of the process of the present invention; and

FIG. 9 is an example of an Affinity Diagram from an Affinity Analysis in a representative example of the process of the present invention.

### DETAILED DESCRIPTION OF THE PREFERRED EMBODIMENT

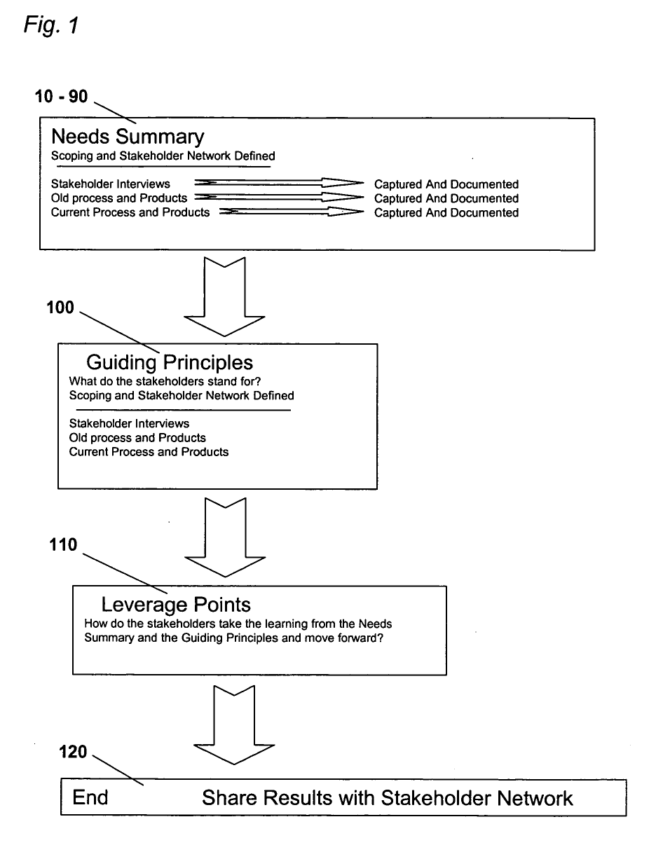

The process and apparatus for creating Guiding Principles and Leverage Points for aligning Stakeholder Interests of an Organizational Group according to the present invention is described below in connection with FIGS. 1-5. The terms, such as Stakeholder, Guiding Principles and Leverage Points, as used herein are described above. The present invention is designed to diffuse individual Stakeholder interests and biases. The individual Stakeholder interests are eliminated, or at least minimized in the present invention, through customized Stakeholder questions presented in a specific ordered fashion to representative group of Stakeholders in individual interviews. The ordered fashion positions questions relating to matters external to the Organizational Group before questions relating to matters internal to the Organizational Group. An Affinity Analysis on responses from the Stakeholder interviews provides the analysis needed for creating Guiding Principles and Leverage Points for aligning Stakeholder Interests that are approved by the Stakeholder leaders and presented to the Stakeholders. The apparatus includes i) a graphical representation of a Stakeholder Network; ii) an ordered customized Stakeholder Interview Worksheet; iii) a computer database of individual Stakeholder responses the Stakeholder Interview Worksheet; and iv) at least one graphical Affinity Analysis diagram of separated responses from the computer database.

The process according to the present invention may be subdivided into four main segments, namely a Needs Summary portion, a Guiding Principles portion, a Leverage Points portion, and a sharing of the results with the Stakeholders. These are summarized in the overview of FIG. 1. The Needs Summary portion, steps 10-90 as described hereinafter, incorporates a series of structured stakeholder interviews of representative Stakeholders. The Guiding Principles portion, step 100 described below, incorporate using the outputs of the structured interview process to assemble a set of fundamental activities by which achievement and success are measured, as defined by the aggregation of the comments from the stakeholders themselves. The Leverage Points portion, step 110 described below, identifies the means (e.g. the action items) by which improvements and implementation of the Guiding Principles will occur in the Organizational Group. The Leverage Points leverage the skills and capabilities of the stakeholders and utilize the affinities gathered from the various Dimensions collected as part of the Needs Summary portion as specific and actionable activities.

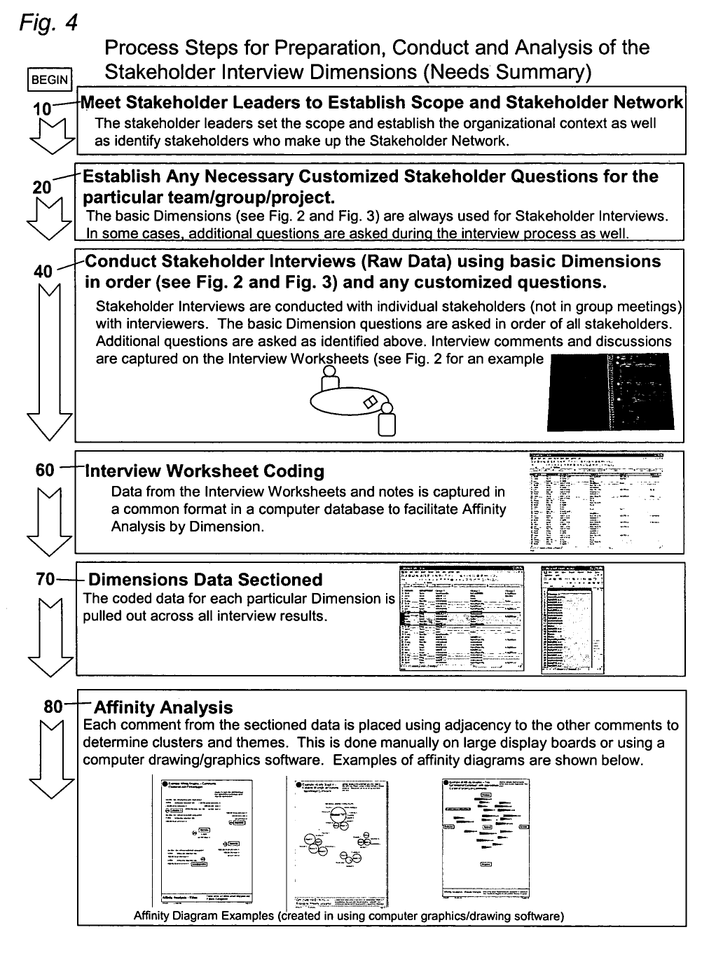

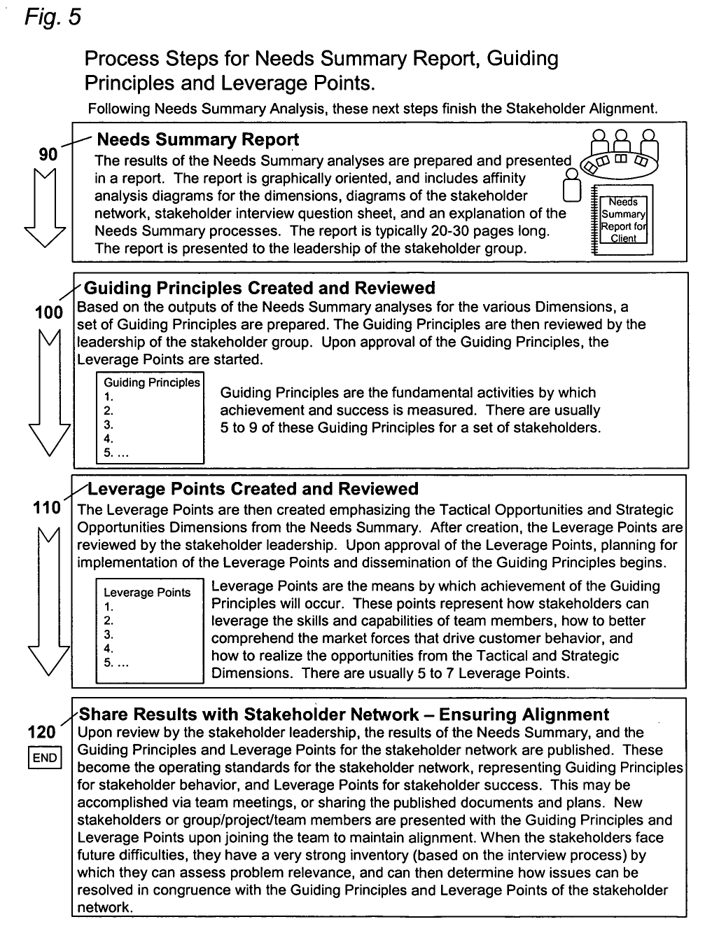

FIG. 4 illustrates the process steps for the preparation, conduct and analysis of the Stakeholder interviews of the representative Stakeholders, specifically the initial eight steps (steps 10-80) of the Needs Summary portion of the present invention. FIG. 5 illustrates the final four process steps of the present invention, including the final step of the Needs Summary portion or the Needs Summary Report 90, the Guiding Principles portion 100, the Leverage Points portion 110, and the final step of sharing the results with the stakeholders at step 120. These are discussed in more detail below.

As noted above, within the meaning of the present application steps 10-90 of the process according to the present invention for creating Guiding Principles and Leverage Points for aligning Stakeholder Interests of a given Organizational Group are grouped together as the Needs Summary portion of the process according to the present invention. In other words the Needs Summary is a specific process incorporating a specific set of ordered or “Dimensional Questions”, presented to stakeholders and the results then analyzed using a KJ Analysis or Affinity Analysis.

The initial step of the Needs Summary portion of the present invention is step 10 which essentially is a meeting between the operator and the Stakeholder Leaders, i.e. a management meeting with the relevant management of the Organizational Group, to define the scope of the project or projects under study. This meeting will also provide the operator or user of the process, also called the consultant or facilitator, with a description and the names of all of the Stakeholders of the organization for the given project(s). Further a representative set of Stakeholders will be determined for subsequent interview, wherein the representative set may be all of the Stakeholders (for small Organizational Groups), but preferably the representative set is a subset of all the Stakeholders with representation from all the relevant groupings of Stakeholders. The groupings of Stakeholders in any Organizational Group will vary depending on the project. For example the groupings may be Highly Compensated Employees, Hourly Employees and Management when considering retirement plans for a company and may be Engineering, Sales and Marketing for another project for the same company. The Stakeholder Network is characterized or defined with input from the Stakeholder Leaders, and the user will create a graphical representation of the Stakeholder Network, also called an Organizational Chart. The Stakeholder Leaders may further provide an identification of primary and secondary stakeholders, where the project warrants further separation of Stakeholder input. For example, the scope of the project may require the alignment of only the primary stakeholders for one part (the issue is not germane to all the Stakeholders) and the alignment of all the stakeholders for a second part.

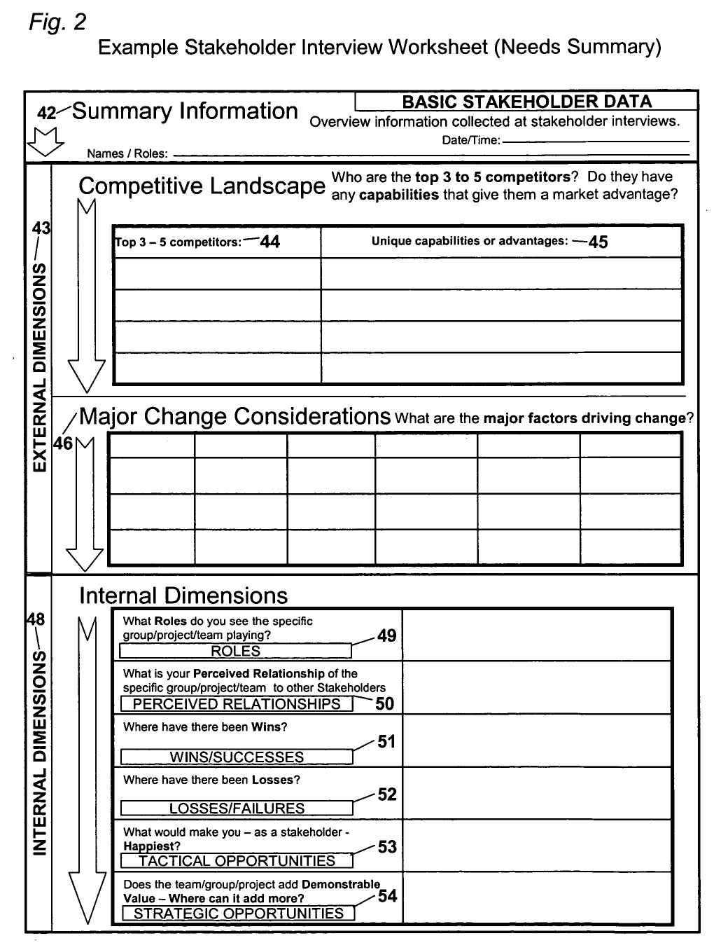

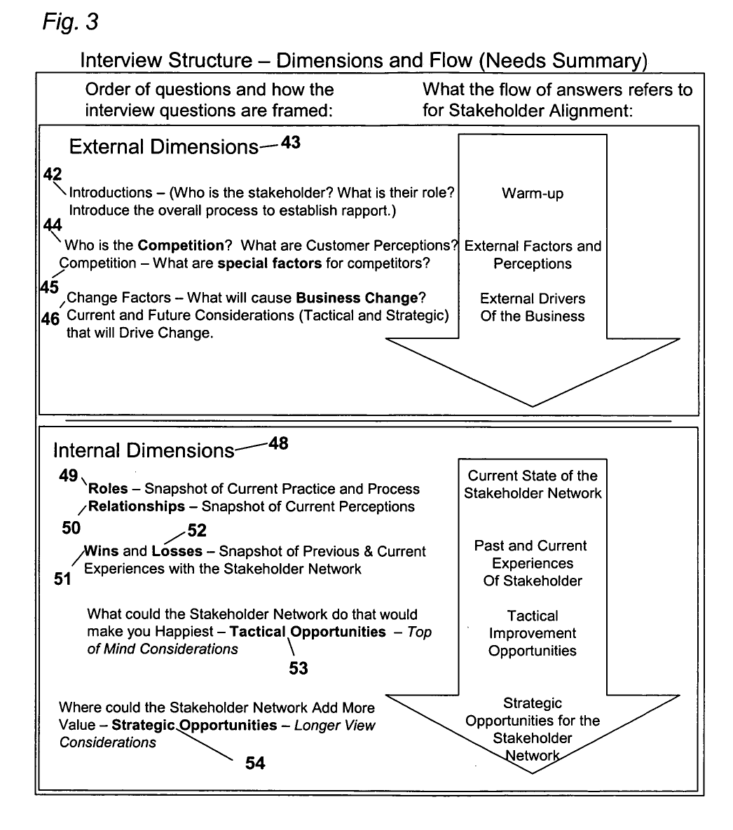

The second step 20 of the process according to the present invention and the second step 20 of the Needs Summary portion is the preparation of the Stakeholder questions by the operator. A set of specific Stakeholder questions will be prepared and each individual representative Stakeholder will be asked the same set of fundamental questions. If there is a division of Stakeholders (Primary and Secondary) then two sets of questions may be prepared, however each representative Stakeholder of each division will be asked the same fundamental questions. An example of a Stakeholder Interview Worksheet is included as FIG. 2. It is a critical feature of the present invention that the Stakeholder internal biases be eliminated or diffused through the organizational structure of the questions, i.e. the ordering of the questions asked. One key feature of the invention is to group the questions into a first group, called the External Dimensions, which are questions relating to factors external to the Organizational Group and a second group, called the Internal Dimensions, which are questions relating to factors internal to the Organizational Group. The Dimensions are also highlighted on FIGS. 2 and 3 and are shown as Items 42-54 on FIG. 2 and FIG. 3. Gathering the Stakeholder input to External Dimensions first has proven to be very effective at minimizing or eliminating Stakeholder biases, greatly improving the ability to receive information needed to align the Stakeholder Interests appropriately.

The following step 40 of the present invention is a series of individual stakeholder interviews or meetings for the representative set of Stakeholders. The individual Stakeholder meetings will include questions which focus along a series of dimensions as noted above, with External Dimensions preceding Internal Dimensions. A typical individual stakeholder meeting is between 30 and 60 minutes in duration. The Stakeholder interviews are carefully structured and FIG. 3 graphically summarizes the Interview Structure and each of the elements, so that a progression of information is gathered along the following Dimensions or groupings: i) Bibliographic Dimension. Basic stakeholder demographic data (Who, What, Role in Stakeholder Network) see Item 42; ii. External Dimensions see Items 43-46; and iii. Internal Dimensions see Items 48-54.

The Bibliographic Dimensions are generally provided by the Stakeholder Leaders in identifying the Stakeholders and generally do not reflect Stakeholder input in the Stakeholder interviews. The Bibliographic Dimensions will generally not be shared in the reporting of the results.

The External Dimensions reflect the beginning of meaningful Stakeholder input in the Stakeholder Interview and may, as an example, include a question asking for the Stakeholders perception of the Competitive Landscape. For example, the Stakeholder may be asked a) What are customer perceptions of the given stakeholder network? (this may be product, team, group, company, etc.); b. Please list the top three to five competitors; and c) What are the unique capabilities or special factors that give competitors market advantage or cause competitors to be a at a market disadvantage? The External Dimensions may, as an example, include a question asking for the Stakeholders perception of the Major Change Considerations, see Item 46. For example the Stakeholder may be asked a) What will cause business change? (These are cited as the major factors driving business change and typically 3 to 6 factors are cited here for the given stakeholder network); and b) What are the current tactical and strategic implications of those major factors that all competitors are facing?

The Internal Dimensions, see items 48-54, reflect the issues internal to the Organizational Group and are often the heart of aligning the Stakeholder Interests. Addressing these issues following the External Dimensions has proven to provide more meaningful results. The Internal Dimensions may, as an example, include a question asking for the Stakeholders perception of the past state of the Stakeholder Network. For example the Stakeholder may be asked about a) Specific successes and failures (wins and losses) that the stakeholder has experienced within the stakeholder network—in particular relating to the group/project/team that is being aligned; b) Any other significant previous experiences with the group/project/team that is being aligned. The Internal Dimensions may, as an example, include a question asking for the Stakeholders perception of the current state of the Stakeholder Network. For example, the Stakeholder may be asked about a) What are the current roles of the stakeholders in the network that relate to the specific team/project/group being aligned?; and b) What are the relationships—the current perceptions of stakeholders within the network? The Internal Dimensions may, as an example, include a question asking for the Stakeholders perception of the tactical and/or strategic opportunities of the Organizational Group. For example, the Stakeholder may be asked about a) What could the stakeholder network—in particular—the team/project/group being aligned do that would make you happiest? (The response to this represents the “top of mind” consideration by the Stakeholder being interviewed as they have already given information about external factors, as well as historical and current internal factors. The natural flow is to next and most tactical improvement opportunities. These represent the tactical opportunities to improve current operations within the stakeholder network—and will make the stakeholder “happiest.”); and b) Does the group/project/team add value to the stakeholder network? If not, how could it add value or should it not exist. If so, how could it add more value. (These responses represent the strategic or longer—term considerations—as they do not merely make the stakeholder happy, but address stakeholder network value propositions).

The Dimensions can be summarized as: i. Basic or Bibliographic Stakeholder Data (Item 42), (Name, Title, Experience Level, Date and Time of Interview); ii. External Factors or Dimensions (Items 43-46), namelyl. Competitors, Unique Capabilities and Perceptions, 2. External Business Change Drivers and Responses; and iii. Internal Factors or Dimensions (Items 48-54), namely 1. Past Experiences of Stakeholders including a. Wins and b. Losses, 2. Current State of the Stakeholder Network including a. Roles and b. Relationships, and 3. Future Opportunities including a. Tactical—“Happiest” and b. Strategic—“Add Value”. One of the key and important differences of this process compared to other business alignment techniques is that Stakeholders aren't explicitly asked leading questions such as “What can we do tactically or strategically?” Rather, by applying customer relationship management techniques and the order of the dimensions, the perceptions, tactical and strategic desires of the Stakeholders are inferred. Further, by assembling the inputs of a significant number of stakeholders, an overall image of the project or group can be assembled that reflects the inputs of all of the Stakeholders.

Following the stakeholder interviews, data analysis of the Stakeholder Interview results is performed. In step 60 the raw data collected, the Stakeholder responses, is entered or coded into a computer database so that the data may be analyzed, electronically if necessary. Following the coding of data, the data is separated or sectioned corresponding to the Dimensions. This is illustrated on FIG. 4, Step 70. After the data sectioning an Affinity Analysis, step 80, is performed for the data of each Dimension (other than the Bibliographic Dimension). A separate Affinity (or modified KJ) Diagram is created for each Dimension and the Affinity Diagram identifies the five to ten largest “clusters” of information provided by stakeholders in each of the question areas above. This is illustrated on FIG. 4, Step 80, which also shows some sample affinity diagrams. The affinity diagram can then be used to graphically depict the affinity states of a given project, process or team—as perceived by the stakeholders along any of the Dimensions that were used for the questioning (for example; affinity diagrams are created for Internal/External/Prior/Current/Relationships/Tactical/Strategic). The affinity diagrams also include statistical summaries such as the percentage of responses in a given affinity state across all stakeholders for a given Dimension.

A Needs Summary Report is prepared, in step 90, after the completion of the affinity analyses. This step is illustrated on FIG. 5 and is the final step of the Needs Summary portion of the present invention. This report is typically 20-30 pages in length, of which 5-7 are text and the remainder of the pages are illustrations of affinity diagrams, an illustration of the Stakeholder Interview Worksheet, as well as stakeholder network diagrams and overall Needs Summary, Guiding Principle and Leverage Point process illustrations. Delivering and or presenting the Needs Summary Report ends the Needs Summary method and commences the next steps toward stakeholder alignment as illustrated on FIG. 5.

Following the Needs Summary portion of the present invention is the Guiding Principles portion as shown in step 100. Following the completion of the affinity diagrams for each of the Dimensions, an overall set of Guiding Principles can be identified by the operator and approved by the Stakeholder Leaders. The Guiding Principles represent the fundamental activities by which achievement and success are measured—as defined by the stakeholders themselves. It is essentially the goal of the Needs Summary portion to provide the material needed for the operator to develop Guiding Principles that are based upon the Stakeholders themselves. The Guiding Principles characterize the strategic statements to guide future endeavors of the group/team/projects. The Guiding Principles is reviewed and approved by the Stakeholder Leaders.

Following the creation of the Guiding Principles and a review of the principles with the stakeholder leadership, a set of Leverage Points are created by the operator in step 110. The Leverage Points are approved by the Stakeholder Leaders and are a description of the means by which improvements and implementation of the Guiding Principles will occur. The Leverage Points leverage the skills and capabilities of the Stakeholders and utilize the affinities gathered from the various Dimensions collected as part of the Needs Summary portion. This is illustrated on FIG. 5, Step 110.

A graphical report of the process is created and delivered to the Stakeholder Leaders or management team. Following review of materials with the Stakeholder Leaders, the findings of the Needs Summary, Guiding Principles and Leverage Points are shared with the entire Stakeholder Network, i.e. all the Stakeholders. This is illustrated on FIG. 5, Step 120, which is the final process step. The format of the final report is based upon the principles of being visually oriented rather than textually oriented. Contents of the report include: a. Details as to the number of stakeholders interviewed, b. Details of the specific questions asked of each representative stakeholder. Each stakeholder is asked the same basic question set, c. Details of the organizational structure for which the Needs Summary has been prepared—this includes the project(s), group(s), or team(s) and how they fit within the overall stakeholder structure, d. Affinity diagrams for the entire stakeholder Dimensions, including statistical summaries and cluster names and percentages of response in each cluster, e. Affinity diagrams and comparisons for tactical and strategic outcomes—as these usually have overlap and represent near—and long—term improvement opportunities, f. A listing of the Leverage Points, g. A listing of the Guiding Principles, and g. summary plan or other representation (as appropriate) suggesting ways for the team/project/group to improve based upon the findings. The results should also be shared with new Stakeholders as they join the Organizational Group.

Many of the individual aspects of the present invention are known separately. For example, Affinity Analysis as a process is attributed to Jiro Kawakita, and itself is not a new concept, it is prior art represented in many management and other design texts and publications. Further, meeting with Stakeholder Leaders and subsequently interviewing Stakeholders in a business context is, by itself, also well known. Creating a set of overarching principles or opportunities for business leverage are well known undertakings. Creating a report of the findings from a study is obviously known. It is the combination of elements and order of this particular process of the present invention that make the invention unique and particularly effective. Further, the order of the Dimensions presented to the stakeholders leads the stakeholders into a discussion pattern where they are highly likely to disclose specific and useful information toward the end goal of stakeholder alignment. By applying the questions in the specific order of Dimensions as set forth the present invention provides value and effective results. The present invention provides a repeatable process and is a unique approach to building stakeholder alignment. The outcomes of this process provide a customized 360 degree view (if all Stakeholder groups or classes are represented in the interviews) of the specific Dimensions of the group/project/team dynamics that cannot be achieved by any other method. Unlike other stakeholder assessment methods which incorporate directed questions which clearly lead the stakeholder to standard responses—the question Dimensions are designed to be independent, and use human-factors engineering and relationship management principles to subtly mask the flow of the underlying Dimensions and so that the “purity” of the interview process is maintained.

The following simplified example is designed to illustrate the basic operation of Stakeholder Alignment process according to the present invention. This example illustrates only one possible embodiment of the invention as applied to an extremely small stakeholder network, having a very small question set, and a very brief analysis. It is merely intended to provide clarity to the elements in the description of the present invention. A typical Stakeholder Alignment process for an Organization Group has considerably more Stakeholders, other dimensions and questions, and a more detailed analysis.

Stakeholder Alignment Example: Gifted Education in Anytown, USA.

Due to a change in state regulations, the school district in Anytown, USA, was now required to conduct a bi-annual review of their “gifted” education program for students who are in the 98^{th} percentile on a battery of academic standards. The district created their gifted education program four years ago, so this was the first significant review. In order to facilitate the creation of the on-going review program, and to ensure that the district would adequately address the needs of the stakeholders for the program, they arranged for the Stakeholder Alignment process to be utilized. Dr. Jones, district superintendent arranged for a consultant to come in and apply the process for the district. Dr. Jones represented the management contact for the process.

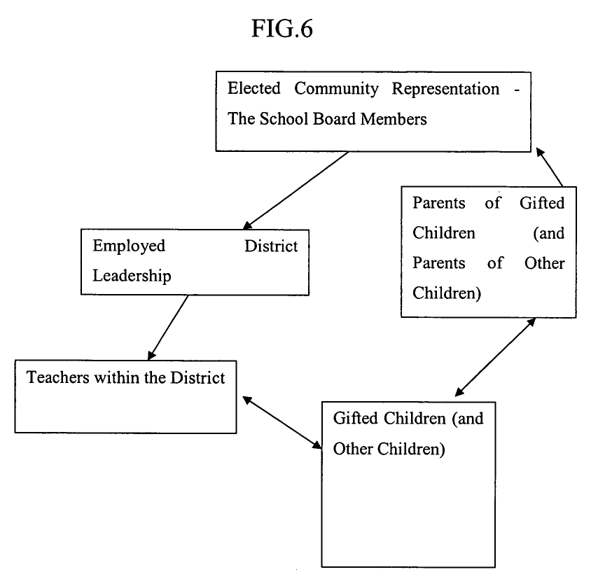

Dr. Jones and the consultant identified the scope of the project and determined the Stakeholder Network within the project scope, wherein the Stakeholder Network, is shown graphically in FIG. 6, and included the following organizational elements:
a) Employed District Leadership
b) Elected Community Representation—The School Board Members
c) Teachers within the District
d) Parents of Gifted Children (and Parents of Other Children)
e) Gifted Children (and Other Children)

Representatives from the District Leadership (Dr. Jones, age 53), a member of the school board (Mr. Smith, age 41), a teacher (Mr. Davis, age 33), a Parent of a Gifted Child (Mrs. Williams, age 34), and a Gifted Child (Mr. Brown, age 11) were selected as the relevant Stakeholders and scheduled for individual interviews to represent the Stakeholder categories as part of the process. In some applications with a smaller number of Stakeholders, each Stakeholder of a given category may be interviewed, however in many applications of the present invention the representative Stakeholders will be a sub-set of all of the Stakeholders.

For the purposes of this example, note the following biases or interests for the identified Stakeholders. Dr. Jones has been an outspoken leader for the formulation of an improved Gifted Education program, but that Mr. Smith has adamantly opposed this in the past. Mr. Smith has been a primary advocate for athletic programs and he owns a sporting goods store in the community. Mr. Smith is also opposed to any new taxation or any spending programs within the community. Mr. Davis is a mathematics teacher, who does have tenure, but has not been offered a position in the district leadership even though he has applied multiple times. Mrs. Williams and her family recently moved to the district from a different state, where her children were participants in a Gifted Education program. Mr. Brown has not yet had the opportunity to participate in a gifted education program, but has an IQ in excess of 150, and has consistently complained of disliking school due to boredom. Mr. Brown is also a member of the top-flight community soccer team, so he is well known among students and parents in the community.

After meeting with Dr. Jones and the district's employed leadership, the stakeholder network was set, the interview candidates established, and the question set created. A Stakeholder Interview Summary sheet was created that essentially was the same in format to that shown in FIG. 2. Following brief introductions and the collection of basic stakeholder data such as name, age, time and date of the interview, there were six basic questions, asked in the following order:
1. (External) Can you characterize the Gifted Education programs of which you are aware in the top three to five school districts in the area?
2. (External) What unique advantages do you see in each of the respective programs that other districts are running successfully?
3. (External) Do you see any specific drivers of change in the Gifted Education programs—either in general or in the specific districts that you cited?
4. (Internal) Can you identify any specific successes that the school has had regarding Gifted Education to date?
5. (Internal) Can you identify any specific failures that the school has had regarding Gifted Education to date?
6. (Internal) As a stakeholder, what would make you happiest regarding Gifted Education in Anytown, USA?

True to form, Mr. Smith made it quite clear during his introduction to the interviewer that he did not see any need for any expansion in taxation or programs, but that he wanted more money spent on sports. Mr. Davis indicated to the interviewer that he was particularly interested in a career path outside of the classroom, and that he was unhappy in his current teaching assignment. Mrs. Williams opened her discussions with a comment that she was glad that the district had invited her, that she had spoken to a number of parents and had “a lot to say” about how gifted education ought to work. Mr. Brown was quiet during the introductory portion of his interview, stating that he was just a student and he didn't care all that much—he wanted less busy work, and that he didn't want his Dad to have to spend more money on “school stuff” unless he was getting a better education. Dr. Jones made it clear that he preferred a couple of particular types of programs, and he was going to push hard for them. These comments were made generically, and were not part of the overall question and analysis process employed. They are provided as overview to establish the perspective and “agendas” of bias of some of the participants.

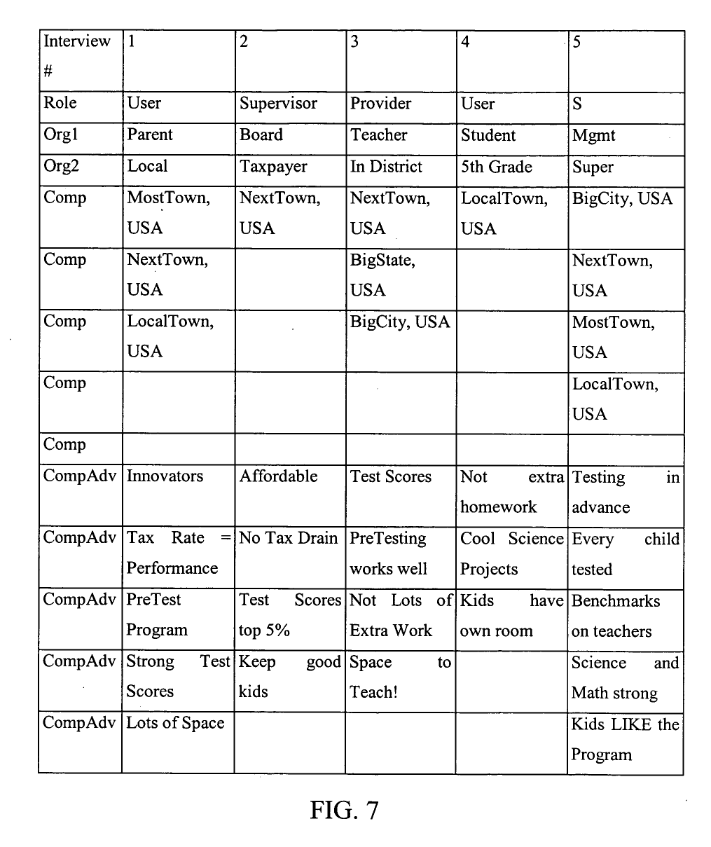

The interviews were conducted as a series of one-on-one meetings with each of the representative Stakeholders. Each interview was one hour in duration, and the set of questions listed above were asked of each stakeholder in that precise order, beginning with discussions related to gifted education EXTERNAL to the Anytown, USA district. Later questions and discussions focused on elements that were INTERNAL to the Anytown school district. Responses from participants in the interviews were recorded by hand onto a question sheet. Following the completion of the interviews, the responses from the participants were coded into a computer database, such as using Microsoft Excel® spreadsheet program as a database, thereby forming a set of tabulated responses that may be sorted and reviewed. FIG. 7 illustrates a portion of the coded data for the purposes of illustrating this example.

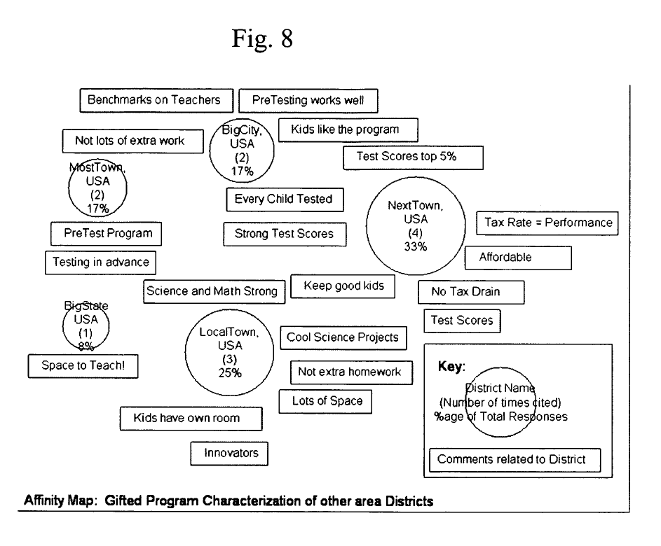

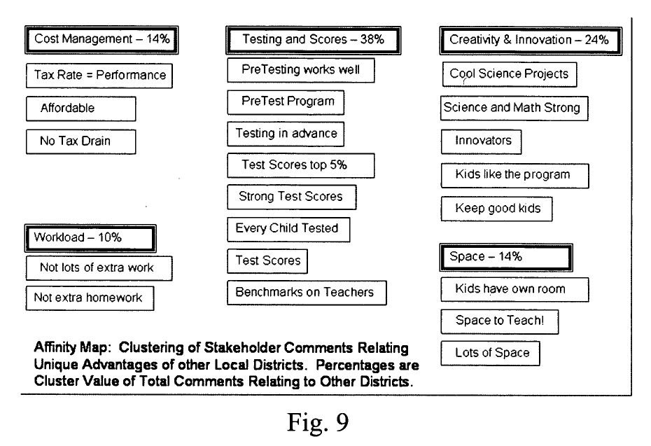

Following the coding and tabulation of the data into a database, the set of replies for the questions were evaluated using a KJ or Affinity Analysis. Two examples of Affinity Diagrams for the present example are shown in FIGS. 8 and 9. Typically these are rendered in color and use unique color encodings to represent clustering effects. Following the coding of the data and the Affinity Analysis, it was clear that there were a few areas that virtually all of the Stakeholders interviewed had noted from the other top districts in the area. These were then formulated into a set of Guiding Principles for the district with regard to gifted education. These are akin to critical success factors or key elements for the direction of the program.

Here is one of the Guiding Principles that was created and its rationale: Guiding Principle 1; Create a program of “No Child Left Unchallenged.” Rationale: Based upon the findings and the considerations in other competitive school districts, it weakens the district when bright children leave and attend private schools in other communities. Those students no longer assist the overall student population with their presence and talents, as well as their positive impact on test scores. By challenging each student uniquely, the opportunity for increased retention of the best and brightest is enhanced. Test scores and external metrics will improve via innovative solutions and ensuring that students have the necessary access to their individualized curriculum needs. The combined totals of the percentage of comments relating to Creativity and Innovation and Testing and Scores reflected 62% of comments about the competitive advantage that was being afforded in other districts. By making this a Guiding Principle, it becomes part of the overall success criteria and culture for the Anytown district and community and moves it toward best practice as employed by competing districts.

Following the creation of the Guiding Principles, a set of Leverage Points were created. These represented tactical opportunities over the next two years that the Anytown, USA school district could act upon.

Following are two of the Leverage Points and their rationale. Leverage Point 1, Repurpose recently updated physical space within each of the schools so that the gifted education program will have the necessary physical room for the unique project needs for gifted students. Rationale: Cramping the district's gifted students into a small space where they were unable to perform experiments, create and build models, or do creative explorations prevents the adoption of broader thinking skills. Competitive districts adjacent to Anytown were providing two to three times the square footage per gifted student in their gifted spaces. The combination of space and creativity reflected a combined 38% of the responses of areas where competitive external districts were achieving an advantage over the Anytown program. Since the district had just completed renovations at each of the district's schools in the past three years to complete Americans with Disabilities Act and other state mandated access requirements—there were at least one additional classroom or laboratory space that was underutilized a significant portion of each day. Allocating the space to the gifted education program was a means of showing support and enhancing the program at relatively little expense. Leverage Point 2, Provide pre-testing during major learning initiatives at every grade level and in every subject. Provide step-up programs for students demonstrating mastery on pre-tests. Rationale: Enhancing the educational experience for students and preventing boring and repetitive lectures on materials already known by students was entirely in concert with Guiding Principle 1 above. 38% of comments by participants indicated that competing districts had strong test score initiatives, and of those 38% of comments, over 40% [4 of 9] related to pre-testing initiatives in the classroom. By challenging students, rather than reviewing known materials, yet teaching the core curriculum, there is a reduction in the need for additional outside teaching resources (which provides cost management). Students can remain with their classmates, yet be learning at a pace more consistent with their own abilities. No compromise is made with regard to mandated testing or curriculum requirements, and no compromise is made with regard to the needs of students who already have mastery of a given subject area or topic. The net effect is that students get work appropriate to their abilities.

Finally, a summary report was prepared which illustrated the overall stakeholder alignment process and included a description of the stakeholder network (constituencies) as graphically shown in FIG. 6, the set of questions, the coded responses (with the unique identifiers by name not made public), the affinity diagrams, as represented in FIGS. 8 and 9, associated with each of the questions, and the set of Guiding Principles and Leverage Points. This summary report was presented at a school board meeting two months after the engagement started for the Stakeholder Alignment process. The Guiding Principles and Leverage Points were approved unanimously by the School Board and are under adoption now.

It will be apparent to those of ordinary skill in the art that various modifications may be made to the present invention without departing from the spirit and scope thereof. The scope of the present invention is defined by the appended claims and equivalents thereto.

1. A process of creating Guiding Principles and Leverage Points for aligning Stakeholder Interests of a given Organizational Group having a defined set of Stakeholders and Stakeholder Leaders, said process comprising the steps of:
A) Establishing a scope for the alignment process and defining a Stakeholder Network within the Organizational Group with input from Stakeholder Leaders;
B) Creating customized Stakeholder questions in an ordered fashion, wherein the ordered fashion positions questions relating to matters external to the Organizational Group before questions relating to matters internal to the Organizational Group;
C) Interviewing representative Stakeholders using the customized Stakeholder questions in an ordered fashion, wherein the representative Stakeholders are asked questions relating to matters external to the Organizational Group before being asked questions relating to matters internal to the Organizational Group;
D) Coding of Stakeholder interview responses in a common format;
E) Separating responses from all Stakeholder interviews at least into responses to questions relating to matters external to the Organizational Group and responses to questions relating to matters internal to the Organizational Group;
F) Conducting an Affinity Analysis on the separated responses from all the Stakeholder interviews;
G) Reporting results of steps B-F to at least the Stakeholder Leaders, wherein the reporting includes graphically displaying at least some of the material associated with steps A-F to the Stakeholder Leaders;
H) Creating Guiding Principles based upon the results, wherein the guiding principles are approved by the Stakeholder Leaders;
I) Creating Leverage Points based upon the guiding principles, wherein the leverage points are approved by the Stakeholder Leaders; and
J) Report results, Guiding Principles and Leverage Points to Stakeholders.

2. The process of creating Guiding Principles and Leverage Points for aligning Stakeholder Interests of claim 1 wherein the step of creating customized Stakeholder questions in an order fashion includes creating a Stakeholder Interview Worksheet in which the ordered fashion positions questions relating to matters external to the Organizational Group in a first grouping physically separated from questions relating to matters internal to the Organizational Group in a second following grouping.

3. The process of creating Guiding Principles and Leverage Points for aligning Stakeholder Interests of claim 2 wherein the grouped questions relating to matters external to the Organizational Group in the first grouping include i) at least one question relating to the Stakeholders perceived listing of competitors of the Organizational group and ii) at least one question relating to the Stakeholders perceived major external factors driving change for the Organizational Group.

4. The process of creating Guiding Principles and Leverage Points for aligning Stakeholder Interests of claim 3 wherein the grouped questions relating to matters internal to the Organizational Group in the second grouping include i) at least one question relating the Stakeholders perceived role within the Organizational Group, ii) at least one question relating to the Stakeholders perceived Stakeholder Network within the Organizational Group, iii) at least one question relating to the Stakeholders perceived wins and losses of the Organizational Group, and iv) at least one question relating to the Stakeholders perceived tactical and/or strategic opportunities for the Organizational Group.

5. The process of creating Guiding Principles and Leverage Points for aligning Stakeholder Interests of claim 1 wherein the step of Interviewing Stakeholders using the customized Stakeholder questions in an ordered fashion is performed individually with each Stakeholder, wherein each Stakeholders is individually asked questions relating to matters external to the Organizational Group before being individually asked questions relating to matters internal to the Organizational Group.

6. The process of creating Guiding Principles and Leverage Points for aligning Stakeholder Interests of claim 1 wherein the step of coding of Stakeholder interview responses in a common format includes forming a computer database of said Stakeholder interview responses.

7. The process of creating Guiding Principles and Leverage Points for aligning Stakeholder Interests of claim 6 wherein the step of conducting an Affinity Analysis on the separated responses from all the Stakeholder interviews is performed using computer graphics software.

8. The process of creating Guiding Principles and Leverage Points for aligning Stakeholder Interests of claim 1 wherein the step of reporting results of steps B-F to at least the Stakeholder Leaders includes graphically displaying i) at least some Affinity Analysis diagrams created in step F, ii) the Stakeholder Network defined in Step A, and iii) a Stakeholder Interview Worksheet created in Step B.

9. The process of creating Guiding Principles and Leverage Points for aligning Stakeholder Interests of claim 1 wherein there are 5-9 Guiding Principles created in step H.

10. The process of creating Guiding Principles and Leverage Points for aligning Stakeholder Interests of claim 9 wherein there are 5-7 Leverage Points created in step I.

11. An apparatus for assisting in the creation of Guiding Principles and Leverage Points for aligning Stakeholder Interests of a given Organizational Group having a defined set of Stakeholders and Stakeholder Leaders, said apparatus comprising:
A) A graphical representation of a Stakeholder Network within the Organizational Group, wherein said graphical representation of a Stakeholder Network is created with input from Stakeholder Leaders;
B) A customized Stakeholder Interview Worksheet in which questions relating to matters external to the Organizational Group are positioned in a first grouping physically separated from questions relating to matters internal to the Organizational Group in a second following grouping, whereby Stakeholder questions are presented in an ordered fashion;
C) A computer database of individual Stakeholder responses to the questions of the Stakeholder Interview Worksheet; and
D) at least one graphical Affinity Analysis diagram of separated responses from the computer database of the individual Stakeholder responses.

12. The apparatus for assisting in the creation of Guiding Principles and Leverage Points for aligning Stakeholder Interests of a given Organizational Group of claim 11 wherein the grouped questions relating to matters external to the Organizational Group in the first grouping include i) at least one question relating to the Stakeholders perceived listing of competitors of the Organizational group and ii) at least one question relating to the Stakeholders perceived major external factors driving change for the Organizational Group.

13. The apparatus for assisting in the creation of Guiding Principles and Leverage Points for aligning Stakeholder Interests of a given Organizational Group of claim 12 wherein the grouped questions relating to matters internal to the Organizational Group in the second grouping include i) at least one question relating the Stakeholders perceived role within the Organizational Group, ii) at least one question relating to the Stakeholders perceived Stakeholder Network within the Organizational Group, iii) at least one question relating to the Stakeholders perceived wins and losses of the Organizational Group, and iv) at least one question relating to the Stakeholders perceived tactical and/or strategic opportunities for the Organizational Group.

14. The apparatus for assisting in the creation of Guiding Principles and Leverage Points for aligning Stakeholder Interests of a given Organizational Group of claim 11 wherein each graphical Affinity Analysis on the separated responses from all the Stakeholder interviews is formed using computer graphics software.

15. A process of providing an analysis for developing Guiding Principles and Leverage Points for aligning Stakeholder Interests of a given Organizational Group having a defined set of Stakeholders and Stakeholder Leaders, said process comprising the steps of:
A) Establishing a scope for the alignment process and defining a Stakeholder Network within the Organizational Group with input from Stakeholder Leaders;
B) Creating customized Stakeholder questions in an ordered fashion, wherein the step of creating customized Stakeholder questions in an order fashion includes creating a Stakeholder Interview Worksheet in which the ordered fashion positions questions relating to matters external to the Organizational Group in a first grouping physically separated from questions relating to matters internal to the Organizational Group in a second following grouping;
C) Individually interviewing representative Stakeholders using the customized Stakeholder questions on the Stakeholder Interview Worksheet, wherein the Stakeholders are asked questions relating to matters external to the Organizational Group before being asked questions relating to matters internal to the Organizational Group;
D) Coding of Stakeholder interview responses in a common format;
E) Separating responses from all Stakeholder interviews at least into responses to questions relating to matters external to the Organizational Group and responses to questions relating to matters internal to the Organizational Group;
F) Conducting an Affinity Analysis on the separated responses from all the Stakeholder interviews; and
G) Reporting results of steps B-F to at least the Stakeholder Leaders, wherein the reporting includes graphically displaying at least some of the material associated with steps A-F to the Stakeholder Leaders.

16. The process of claim 15 wherein the grouped questions relating to matters external to the Organizational Group in the first grouping include i) at least one question relating to the Stakeholders perceived listing of competitors of the Organizational group and ii) at least one question relating to the Stakeholders perceived major external factors driving change for the Organizational Group.

17. The process of claim 15 wherein the grouped questions relating to matters internal to the Organizational Group in the second grouping include i) at least one question relating the Stakeholders perceived role within the Organizational Group, ii) at least one question relating to the Stakeholders perceived Stakeholder Network within the Organizational Group, iii) at least one question relating to the Stakeholders perceived wins and losses of the Organizational Group, and iv) at least one question relating to the Stakeholders perceived tactical and/or strategic opportunities for the Organizational Group.

18. The process of claim 15 wherein the step of coding of Stakeholder interview responses in a common format includes forming a computer database of said Stakeholder interview responses.

19. The process of claim 18 wherein the step of conducting an Affinity Analysis on the separated responses from all the Stakeholder interviews is performed using computer graphics software.

20. The process of claim 20 wherein the step of reporting results of steps B-F to at least the Stakeholder Leaders includes graphically displaying i) at least some Affinity Analysis diagrams created in step F, ii) the Stakeholder Network defined in Step A, and iii) a Stakeholder Interview Worksheet created in Step B.
